(19) United States
(12) Patent Application Publication
(10) Pub. No.: US 2007/0223212 A1
(43) Pub. Date: Sep. 27, 2007

(54) Illuminated Dynamic Cue

(76) Inventor: Yin-Wang Hsieh, Dongguan (CN)

Correspondence Address: GLOBAL IP SERVICES, 2462 ROCK ST., APT. 6, MOUNTAIN VIEW, CA, 94043, US

(21) Appl. No.: 11/278,455

(22) Filed: Apr. 3, 2006

(30) Foreign Application Priority Data
Mar. 27, 2006 (CN) 200620056768.1

(51) Int. Cl. A45B 3/02; F21L 4/00

(52) U.S. Cl. 362/102; 362/183

(57) ABSTRACT

The patent invention relates to the field of sports equipment and reveals an illuminated dynamic cue. The cue is a hollow staff comprised of thread-connected segments, in which illuminating devices are installed. The said illuminating devices consist of power, the IC control part and illuminating components. The staff in which the illuminating components are installed is made from transparent materials. In addition, the cue is equipped with a power switch and a mode switch fitting with the control parts. Users can switch on the power when using and select illuminating modes of the illuminating parts through the mode switch to enliven the cue, offering more fun to the play.

### CROSS REFERENCE TO THE RELATED PATENT APPLICATION

This patent application claims the priority benefit of the Chinese patent application No. 200620056768.1 filed on Mar. 27, 2006.

### FIELD OF THE INVENTION

The patent invention relates to sports equipment, especially an illuminated cue.

### BACKGROUND OF THE INVENTION

Billiards is a widely played game. As a basic device, cues play an important role in the game. As for those cues on the market, they are of different types, however most of them are solid and can do nothing but hit billiards. Due to their singleness in function, they cannot arouse attentions of fashion-pursuing persons, especially youths. To solve the problem, someone had designed illuminating cues. However, the illuminating cues have only one illuminating mode and the color and frequency of light are non-adjustable. Furthermore, batteries used in the illuminating cues are common dry batteries which require frequent bothering replacements.

### SUMMARY OF THE INVENTION

The invention aims at providing a new cue which is able to emit color lights according to users' needs offering the game with more fun.

To realize the purpose, the invention is a hollow staff comprised of thread-connected segments, in which illuminating devices are installed. The said illuminating devices consist of power, the IC control part and LEDs. The staff in which LEDs are installed is made from transparent materials. In addition, the cue is equipped with a power switch and a mode switch fitting with the control parts.

The power supply applies rechargeable battery and the cue also has charging device connecting with the said battery installed in the staff.

The said illuminating device is LED.

The said power switch is ring-slipped on the end segment of the cue and the said mode switch is a key type switch and conveniently fixed on the segment before the end one. And LEDs can be installed in all segments of the said cue.

The said power supply and LEDs are all equipped with transparent sleeves to protect power supply and LEDs.

The end of the end segment is fixed with a shockproof spacer to reduce shacks caused when the cue is placed on the floor.

The benefits of the invention are as follows: due to use of IC control parts and illuminating parts in the cue, users can switch on the power when using and select illuminating modes of the illuminating parts through the mode switch to enliven the cue, offering more fun to the play. Furthermore, the invention is powered by rechargeable battery which can fit in with charging devices. When used up, the battery can be charged by external power supply (as electric supply), avoiding bothers brought by frequent battery replacement and benefiting environmental protection.

### BRIEF DESCRIPTION OF THE DRAWINGS

The following is the further description of the invention given together with attached drawings.

FIG. 1 is an overall structural schematic diagram of the embodiment one of the invention.

FIG. 2 is a decomposition schematic diagram of the embodiment one of the invention.

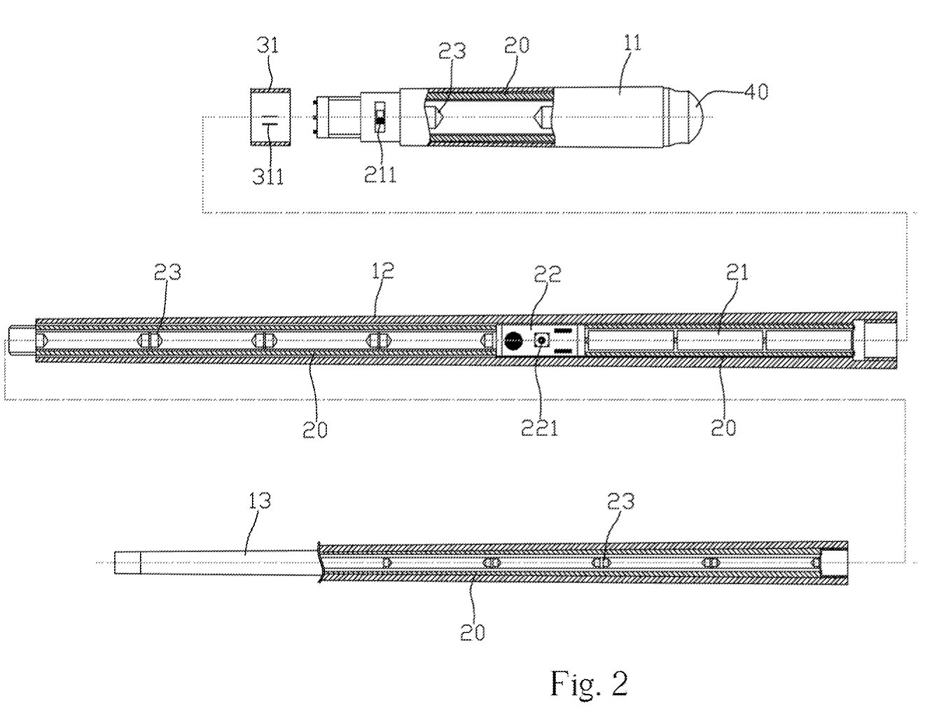

FIG. 3 is an overall structural schematic diagram of the embodiment two of the invention.

FIG. 4 is a decomposition schematic diagram of the embodiment two of the invention.

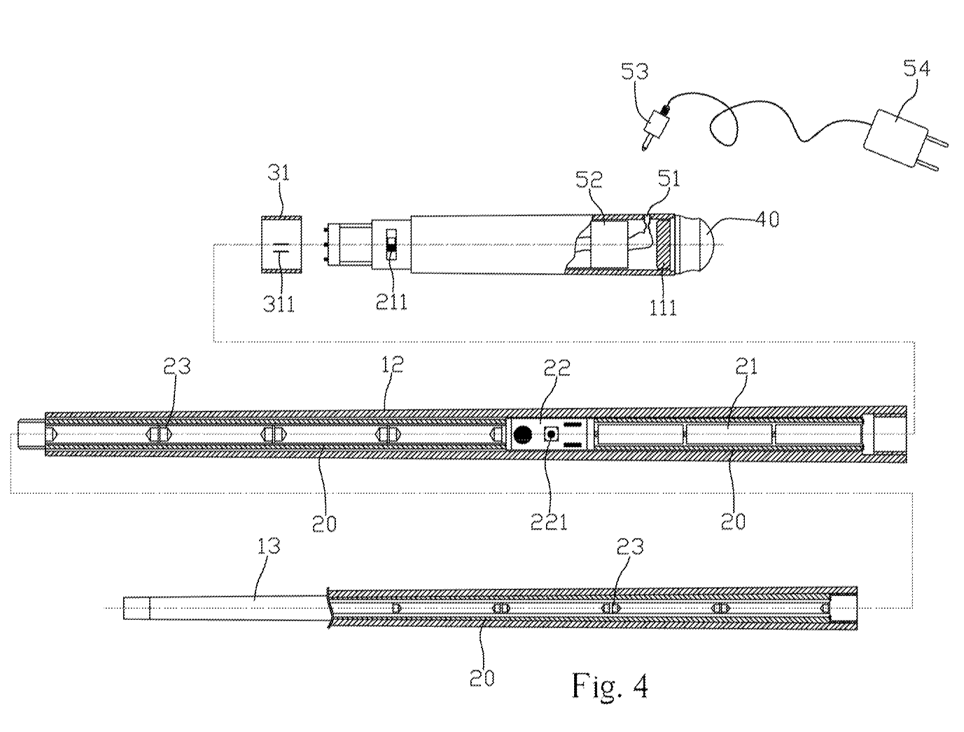

### DETAILED DESCRIPTION OF THE INVENTION

The description below is only to show the preferred embodiments of the invention and will not limit the scope of the invention.

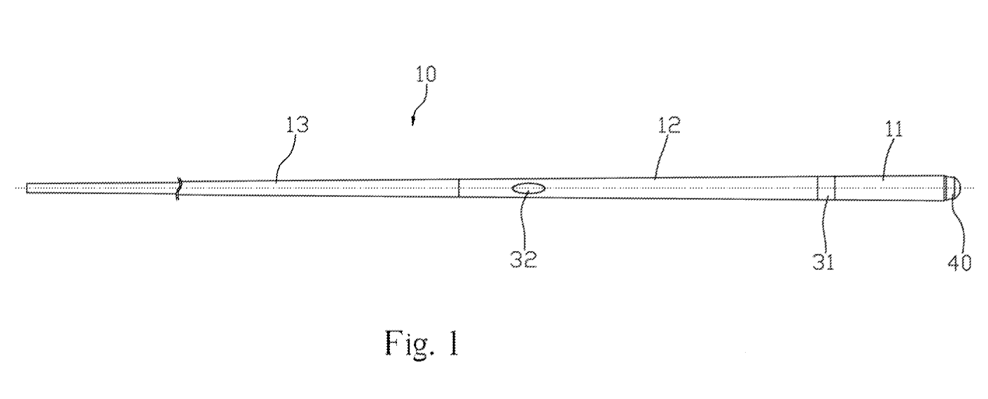

See FIG. 1 & 2: the cue 10 of the invention is comprised of thread-connected staff segments 11, 12 and 13. The middle segment 12 is installed with an illuminating device which comprises three batteries 21, the IC control part 22 and illuminating parts 23 (illuminating parts 23 apply high brightness, low power-consumption and long life LEDS). Batteries 21, control parts 22 and LEDs 23 are connected via wires (not shown in the diagram). To protect batteries 21 and LEDs 23, they can be fitted into the transparent sleeve 20. Additionally, LEDs 23 are packaged into illuminating bars by glass. This can further protect LEDs 23 and also convenience assembly and disassembly between LEDs 23 and the transparent sleeve 20.

In order to make light emitted by LEDs 23 invisible, the staff in which LEDs 23 are installed should be made from transparent materials (transparent or semi-transparent). In addition, the cue 10 is equipped with power switch 31 and mode switch fitting with the control part 22. The power switch 10 is ring-slipped on the end segment 11 of the cue 10 and its inner wall has two parallel bulges 311 for clamping ON/OFF switch 211 on the front joint of the staff segment 11. The mode switch 32 is a key type switch and fixed on the middle staff segment 12 of the cue 10. And its position fits in with the key 221 of the control parts 22. According to users' preference or needs, LEDs 23 can be installed in all staff segments 11, 12 and 13 of the cue 10. Thus the whole cue will be illuminated.

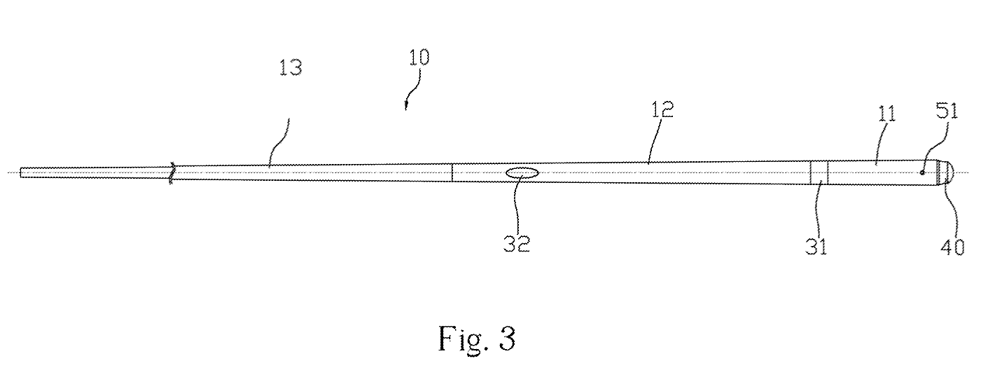

In addition, see FIG. 3 & 4: to avoid frequent battery replacement, rechargeable batteries can be used to power illuminating devices and be charged by the charging device. To realize the purpose, a charging jack 51 can be set on the end staff segment 11 to connect with batteries 21 through charging circuit 52 in the staff segment 11. The charging circuit 52 is a common circuit and will not be described here. Besides, an external charger 54 with plug 53 shall be prepared. When the batteries 23 are used up, they can be charged by connecting the charger 54 to external power supply and inserting the plug 53 into the charging jack 51 on the staff segment 11.

It should be noted that the charging device can be installed on places on the cue 10 other than the segment 11. But it is easy to use when installed in the segment 11. In order to convenience examination of the charging circuit in the staff segment 11, a moving bottom cap 111 can be installed at the end of the staff segment 11. The bottom cap 111 and the staff segment 11 can be threaded together. Since users like standing the cue 10 on the floor during intervals between games, in order to prevent damages to the illuminating devices in the cue 10, a shockproof spacer 40 is fixed on the bottom cap 111 of the staff segment 11.

When using this invention cue 10, users can rotate the power switch 31 to drive the ON/OFF switch 211 to ON, and then press the mode switch 32 to select required illuminating mode (illuminating in order or simultaneously). The integrated circuit (IC) of the control part 22 controls LEDs 23 to emit color lights producing dynamic effects.

What is claimed is:

1. An illuminated dynamic cue comprising:
a hollow staff, which is connected by segments;
an illumination device for illuminating dynamic including illuminating components, an IC control part and a power, all of which are installed in said segments;
a mode switch for controlling the illuminating mode of the illumination device;
a power switch for power on or off of the illumination device;
said segments in which the illuminating components being installed are transparent.

2. The illuminated dynamic cue of claim 1, wherein said power is rechargeable batteries

3. The illuminated dynamic cue of claim 2, wherein further comprise a charging device connected with said rechargeable batteries.

4. The illuminated dynamic cue of claim 1, wherein said illuminating device is LED.

5. The illuminated dynamic cue of claim 1, wherein said segments have three, they are connected together by thread.

6. The illuminated dynamic cue of claim 5, wherein said power switch is a ring-slipped on the end segment of the cue, said mode switch is a key type switch and fixed on the segment before the end one.

7. The illuminated dynamic cue of claim 4, wherein said LEDs are installed in all segments.

8. The illuminated dynamic cue of claim 4, wherein said powers and said LEDs are all equipped with transparent sleeves.

9. The illuminated dynamic cue of claim 3, wherein said charging device is installed in the end segment, which has a moveable bottom cap.

10. The illuminated dynamic cue of claim 9, wherein said bottom cap is equipped with a shockproof spacer.

11. The illuminated dynamic cue of claim 4, wherein said illuminating mode of LEDs is illuminating in order or simultaneously or color lights to producing dynamic effects.
